(19) United States
(12) Patent Application Publication
(10) Pub. No.: US 2006/0002468 A1
(43) Pub. Date: Jan. 5, 2006

(54) Frame storage method

(76) Inventors: Minhua Zhou, Plano, TX (US); Wai-Ming Lai, Plano, TX (US)

Correspondence Address: TEXAS INSTRUMENTS INCORPORATED, P O BOX 655474, M/S 3999, DALLAS, TX, 75265, US

(21) Appl. No.: 11/158,684

(22) Filed: Jun. 22, 2005

Related U.S. Application Data
(60) Provisional application No. 60/582,354, filed on Jun. 22, 2004.

(51) Int. Cl. H04B 1/66; H04N 11/02; H04N 11/04; H04N 7/12

(52) U.S. Cl. 375/240.12; 375/240.24; 375/240.29

(57) ABSTRACT

The memory access efficiency for video decoding is maximized by interleaved storage of luminance and chrominance data. Macroblocks of luminance and chrominance interleave to blocks of 16×32 by repeating chrominance rows.

### CROSS-REFERENCE TO RELATED APPLICATIONS

This application claims priority from provisional application No. 60/582,354, filed Jun. 22, 2004. The following coassigned pending patent applications disclose related subject matter.

### BACKGROUND

The present invention relates to digital video signal processing, and more particularly to devices and methods for video compression.

Various applications for digital video communication and storage exist, and corresponding international standards have been and are continuing to be developed. Low bit rate communications, such as, video telephony and conferencing, led to the H.261 standard with bit rates as multiples of 64 kbps. Demand for even lower bit rates resulted in the H.263 standard.

H.264/AVC is a recent video coding standard that makes use of several advanced video coding tools to provide better compression performance than existing video coding standards such as MPEG-2, MPEG-4, and H.263. At the core of all of these standards is the hybrid video coding technique of block motion compensation plus transform coding. Block motion compensation is used to remove temporal redundancy between successive images (frames), whereas transform coding is used to remove spatial redundancy within each frame. FIGS. 2a-2b illustrate H.264/AVC functions which include a deblocking filter within the motion compensation loop to limit artifacts created at block edges.

Traditional block motion compensation schemes basically assume that between successive frames an object in a scene undergoes a displacement in the x- and y-directions and these displacements define the components of a motion vector. Thus an object in one frame can be predicted from the object in a prior frame by using the object's motion vector. Block motion compensation simply partitions a frame into blocks and treats each block as an object and then finds its motion vector which locates the most-similar block in the prior frame (motion estimation). This simple assumption works out in a satisfactory fashion in most cases in practice, and thus block motion compensation has become the most widely used technique for temporal redundancy removal in video coding standards

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264. The residual (prediction error) block can then be encoded (i.e., transformed, quantized, VLC). The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264 uses an integer approximation to a 4×4 DCT.

For predictive coding using block motion compensation, inverse-quantization and inverse transform are needed for the feedback loop. The rate-control unit in FIG. 3a is responsible for generating the quantization step (qp) in an allowed range and according to the target bit-rate and buffer-fullness to control the transform coefficients' quantization unit. Indeed, a larger quantization step implies more vanishing and/or smaller quantized coefficients which means fewer and/or shorter codewords and consequent smaller bit rates and files.

During decoding, the macroblocks are reconstructed one by one, and are stored in memory until a whole frame is ready for display. In most embedded applications such as digital still cameras and mobile TVs, the decoding is performed in an programmable multimedia processor whose internal memory is limited. The large amount of reconstructed frame data hence must be stored in external memory.

Apart from the need of writing reconstructed macroblocks to the external memory, a multimedia processor also needs to read in previous frame data to perform motion-compensated prediction during decoding. The prediction applies to both luminance and chrominance blocks. Accessing external memory is expensive and can increase the processor loading significantly. Direct memory access (DMA) is one of the many ways for a processor to read from or write to external memory efficiently. However, DMA requires expensive start-up overhead and its efficiency depends on whether each read or write burst (e.g., 64 bytes) is fully utilized.

### SUMMARY OF THE INVENTION

The present invention provides image storage with interleaved luminance and chrominance blocks. This allows for efficient direct memory accessing.

### BRIEF DESCRIPTION OF THE DRAWINGS

FIGS. 1-2 illustrate video data storage.

FIGS. 3a-3b show video coding functional blocks.

FIGS. 4a-4b illustrate applications.

FIGS. 5-6 show video block read from storage.

FIGS. 7a-7b show alternative video block storage.

### DESCRIPTION OF THE PREFERRED EMBODIMENTS

1. Overview

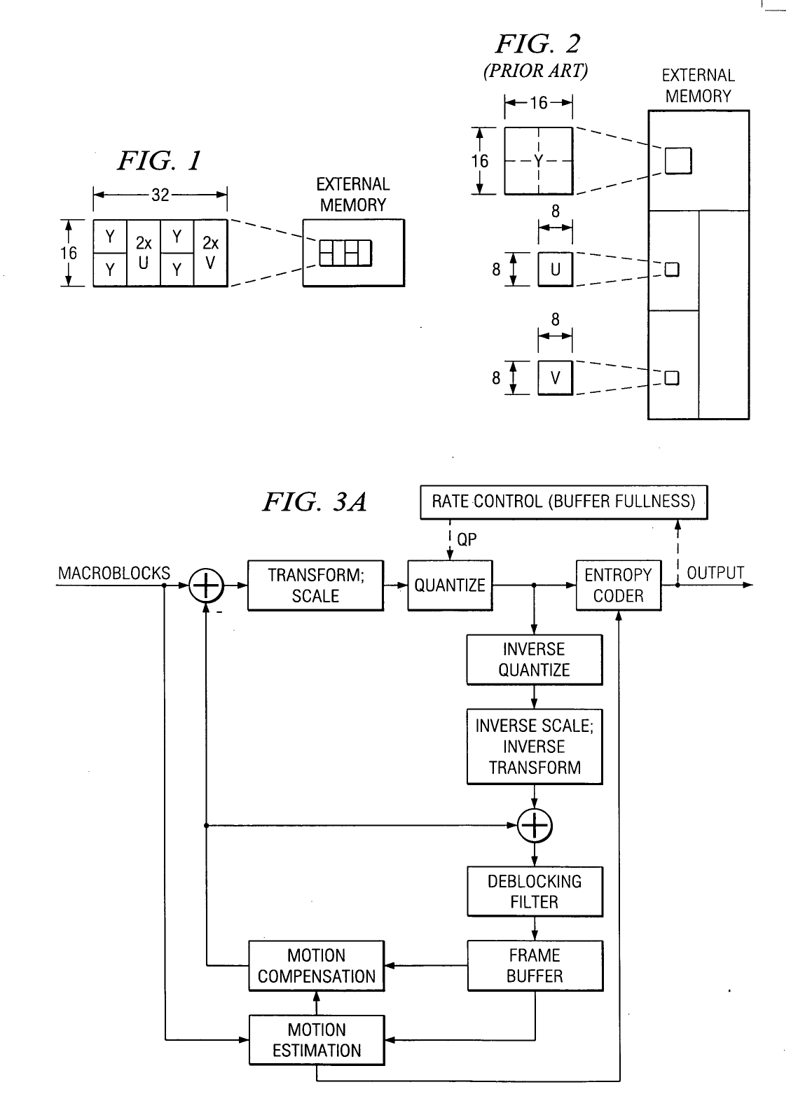

Preferred embodiment methods minimize the number of external memory accesses for block-based video coding; frame data is stored in interleaved luminance/chrominance format instead of in separated format. In particular, preferred embodiment interleaved format illustrated in FIG. 1 stores data in the order of YUYV in each row and the chrominance components are repeated every other row. In this way, the number of DMA read/write bursts can be reduced by 50% and the DMA start-up overhead by 67%. Another advantage of the interleaved storage format is that it matches the format required by built-in display hardware unit in some programmable multimedia processors.

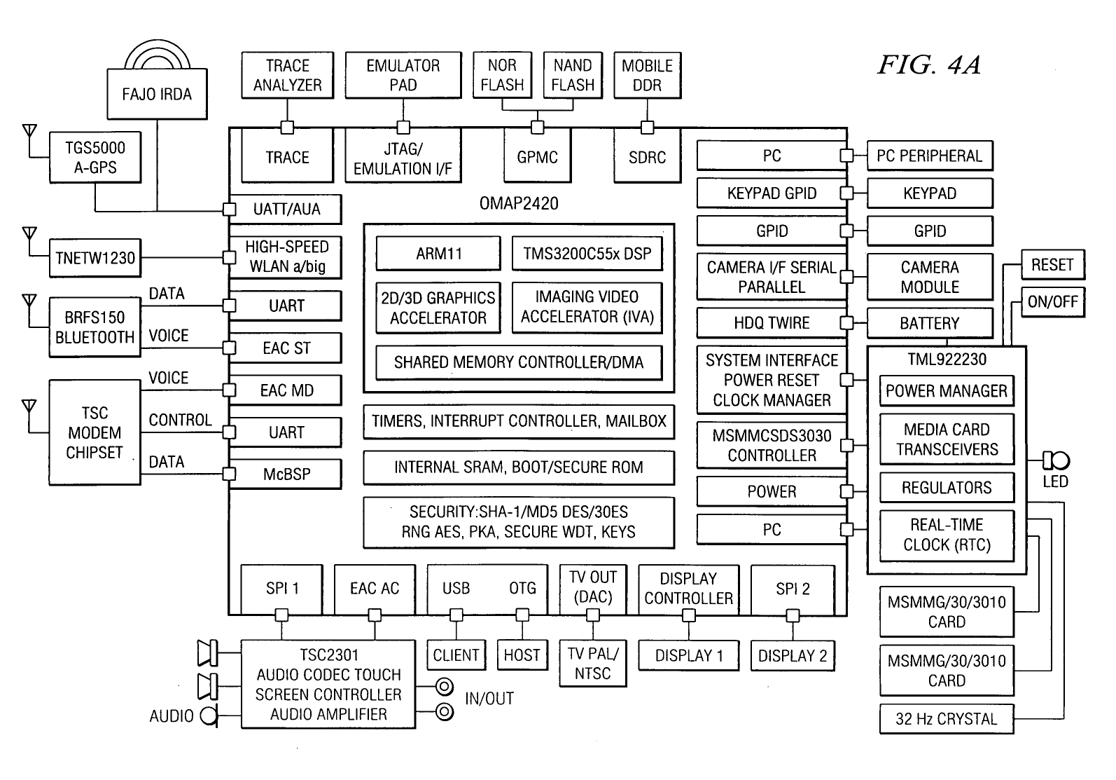

Preferred embodiment systems (e.g., cellphones, PDAs, digital cameras, notebook computers, etc.) perform preferred embodiment methods with any of several types of hardware, such as digital signal processors (DSPs), general purpose programmable processors, application specific circuits, or systems on a chip (SoC) such as multicore processor arrays or combinations such as a DSP and a RISC processor together with various specialized programmable accelerators (e.g., FIG. 4a). A stored program in an onboard or external (flash EEP) ROM or FRAM could implement the signal processing methods. Analog-to-digital and digital-to-analog converters can provide coupling to the analog world; modulators and demodulators (plus antennas for air interfaces such as for video on cellphones) can provide coupling for transmission waveforms; and packetizers can provide formats for transmission over networks such as the Internet as illustrated in FIG. 4b.

2. Preferred Embodiment Memory Write

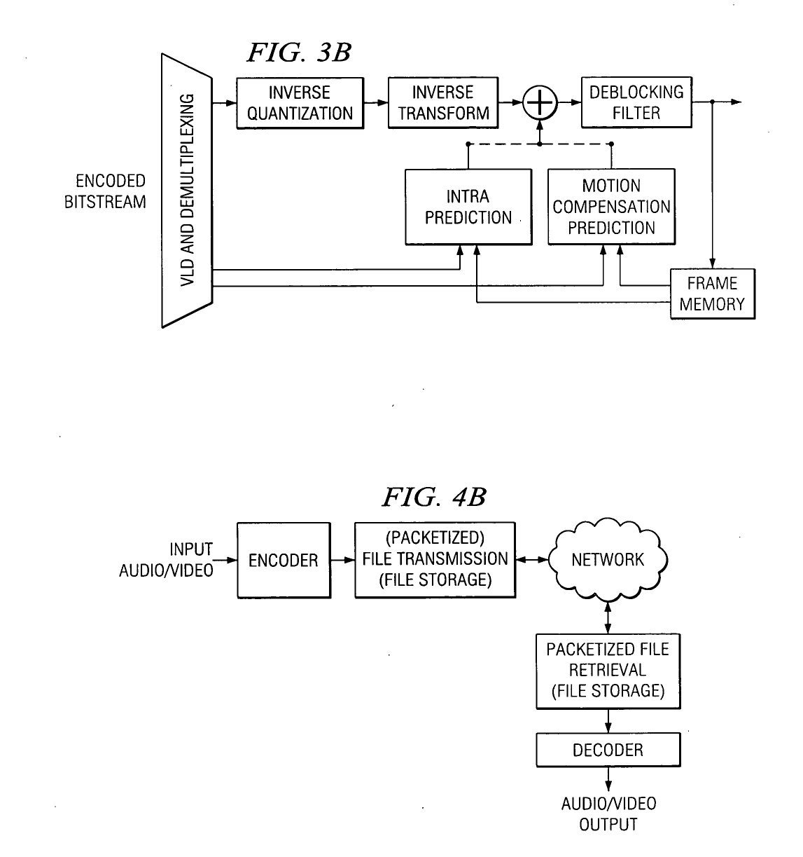

FIGS. 3a-3b illustrate encoding and decoding in a block-based motion-compensated video coding scheme; both encoding and decoding use macroblock reconstructions. After each macroblock is reconstructed (including any in-loop deblocking filtering), the data has to be copied from the internal memory to the external memory where the whole frame resides. FIGS. 1-2 show the differences between writing out the reconstructed macroblock in interleaved (preferred embodiment) format and separated (prior art) format, respectively. In FIG. 2 the three macroblock components are written to the external memory individually, which means that memory access to store a macroblock has to be set up three times: once for each of Y, U, and V data. And assuming that each row of data is written in one burst, a total of 32 bursts are required: 16 rows for Y and 8 for each of U and V. However, in preferred embodiment interleaved format, as shown in FIG. 1, only one memory access set-up and 16 bursts are required, although the bursts are longer. The total time of memory access for the two formats is summarized as follows:
Time required for separated format=(16+8+8)*T_{wr}+3*Tₒₕ=32*T_{wr}+3*Tₒₕ
Time required for interleaved format=16*T_{wr}+Tₒₕ
Where
T_{wr}=time for each write burst
Tₒₕ=time for start-up overhead
   The illustration in FIGS. 1-2 of the external memory as two-dimensional arrays representing a frame (luminance and chrominance) is to be understood as memory addresses incrementing along a raster scan of the frame. That is, the lines of a frame are stored in raster scan order, and the block structure of the video coding is ignored. However, the stored frame is used in the video coding, and the preferred embodiments simplify the access of block-type portions of the stored frame by the interleaving of the luma and chroma data. In FIG. 1 the “2×U” and “2×V” indicate the repetition of the chroma data so it aligns with the corresponding rows of luma data.

As an example, for a VGA frame (640×480 pixels, 40×30 macroblocks), the FIG. 2 prior art stores the Y data in 307200 (=640*480) consecutive memory locations followed by 76800 (=320*240) consecutive memory locations for chroma-U data and then another 76800 locations for chroma-V data. In the stored Y data, incrementing the memory address by 640 is the same as going down to the pixel in the next row of the frame; and similarly, incrementing the address in the memory locations with chroma data is going down to the next chroma location. However, the chroma data associated with luma data in row N is at memory locations offset in memory from the luma data by roughly (480−N)*640+(N/2)*320 for chroma U and (480−N)*640+(N/2)*320+76800 for chroma V.

In contrast, the preferred embodiment of FIG. 1 has the data organized so that 32 consecutive memory locations correspond to 16 Y data and 16 chroma U/V data. Further, incrementing the memory address by 1280 is the same as going down to the pixel in the next row to get both luma and chroma data. Because there the chroma data is at subsampled pixel locations in a frame, the chroma data is repeated memory so that it is aligned with the luma data from the associated two rows of the frame. Thus incrementing the memory address by 1280 at a chroma data location goes to a location which either repeats the chroma data or is the chroma data for the next two rows of the frame. Incrementing the memory address by 2560 always goes down to the next chroma data.

3. Preferred Embodiment Read

As illustrated in FIGS. 3a-3b, one of the major processes in reconstructing a macroblock is motion-compensated prediction which requires data from previous reconstructed reference frames. Since reference frame data is stored in external memory, it is important to minimize the time of reading reference blocks as well. Motion compensation can be done in different block sizes; and fractional motion vectors require prediction filters. Assuming N_{tap-y} and Nₜₐₚ₋ᵤᵥ are the numbers of taps of the prediction filter for Y data and U/V data, respectively, then prediction of a block size of N*M requires (N+N_{tap-y})*(M+N_{tap-y}) of Y data and twice (N/2+Nₜₐₚ₋ᵤᵥ)*(M/2+Nₜₐₚ₋ᵤᵥ) of U/V data. The total time of memory access for the separated and interleaved formats can be summarized as follows:

$$\begin{matrix}\begin{matrix}Time required for \\ separated format\end{matrix} = ( M + {N}_{tap - y} + M + 2 * {N}_{tap - uv} ) * {T}_{r d} + 3 * {T}_{oh} \\ = ( 2 * M + {N}_{tap - y} + 2 * {N}_{tap - uv} ) * {T}_{r d} + 3 * {T}_{oh}\end{matrix}$$

Time required for interleaved format=(M+N_{tap-y})*T_{rd}+Tₒₕ
Where
T_{rd}=time for each read burst
Tₒₕ=time for start-up overhead
N_{tap-y}=number of taps of prediction filter for Y data
Nₜₐₚ₋ᵤᵥ=number of taps of prediction filter for U/V data

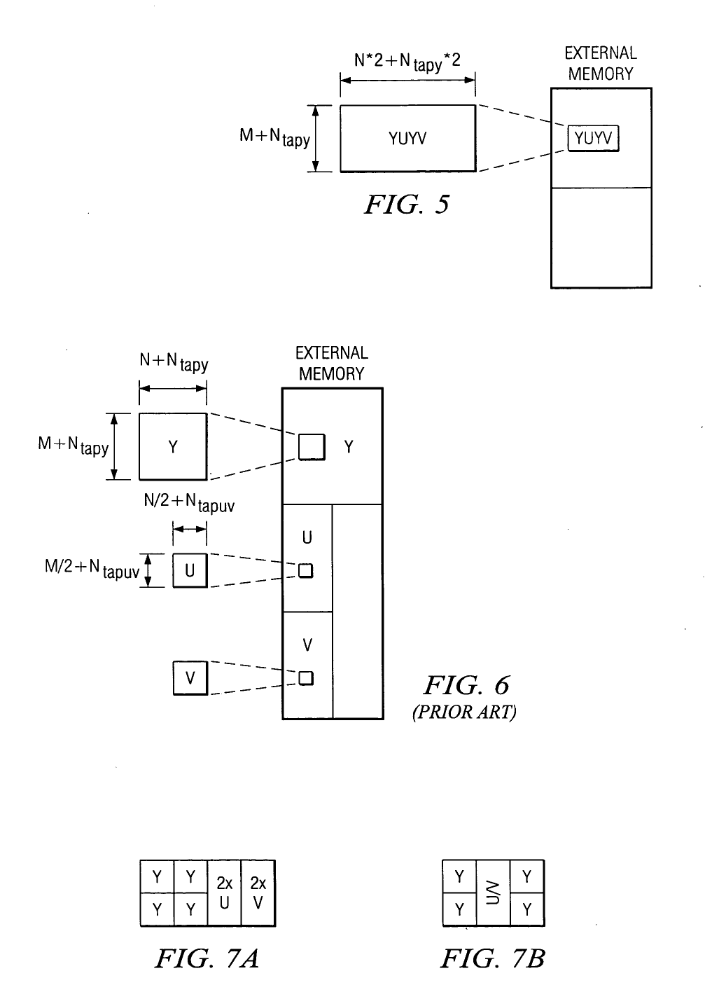

FIG. 5 illustrates the read from a preferred embodiment interleaved storage, whereas FIG. 6 shows the read from prior art storage. Thus, storing the frame data in interleaved YUYV format can reduce the time required for external memory access by more than 50%. And this also eliminates the need for format conversion during display.

H.264 subclause 8.4.2.2.1 has the Y data interpolation filter for fractional pixel motion vectors as separable and with 6 taps in each direction (N_{tap-y}=6), and H.264 subclause 8.4.2.2.2 has the U/V data interpolation filter as bilinear (Nₜₐₚ₋ᵤᵥ=2). Thus to read data for a 16×16 prediction macroblock with a fractional-pixel motion vector from the preferred embodiment interleaved stored frame would require bursts of length at least 38 memory locations.

4. Modifications

The preferred embodiments may be modified in various ways while retaining one or more of the features of interleaved luminance and chrominance block storage.

For example, fields could be used instead of frames, the block sizes could be varied, the color decomposition could have different resolutions (e.g., 4:2:2) so the chrominance block sizes would change, and so forth.

Further, FIG. 7a illustrates an alternative interleaving pairs of luminance blocks and pairs of chrominance blocks. Also, rather than repeat the chrominance rows, the U and V rows could be interleaved as in FIG. 7b. In this case one row would have 16 luminance pixels (a row from each of two 8×8 blocks) plus 8 U pixels (a row from the 8×8 U block), and the next row would have 16 luminance pixels (the next row from the two 8×8 blocks) plus 8 V pixels (a row from the 8×8 V block). Thus the chrominance pixels would be aligned with their corresponding luminance pixels.

What is claimed is:

1. A method of storage of image data, comprising:
(a) providing image data in the form of luminance blocks and chrominance blocks;
(b) storing in successive memory locations a row of data from a first of said luminance blocks, a row of data from one of said chrominance blocks, and a row of data from a second of said luminance blocks, wherein said second luminance block is adjacent said first luminance block in an image, and wherein said chrominance block is associated with said first and second luminance blocks in said image.

2. The method of claim 1, wherein:
(a) said luminance blocks and said chrominance blocks are each 8×8.

3. A video encoder, comprising:
(a) block-based motion compensation encoding circuitry;
(b) said circuitry coupled to a frame buffer;
(c) wherein said circuitry is operable to store luminance blocks and chrominance blocks in said frame buffer in interleaved locations.

4. The encoder of claim 3, wherein:
(a) said circuitry includes a deblocking filter for said luminance blocks and chrominance blocks.

5. A video decoder, comprising:
(a) block-based motion compensation decoding circuitry;
(b) said circuitry coupled to a frame buffer;
(c) wherein said circuitry is operable to read luminance blocks and chrominance blocks stored in said frame buffer in interleaved locations.
